(19) United States
(12) Patent Application Publication
(10) Pub. No.: US 2014/0297404 A1
(43) Pub. Date: Oct. 2, 2014

(54) Obtaining Metrics for Online Advertising Using Multiple Sources of User Data

(71) Applicant: Facebook, Inc., Menlo Park, CA (US)

(72) Inventor: Sean Michael Bruich, Palo Alto, CA (US)

(73) Assignee: Facebook, Inc., Menlo Park, CA (US)

(21) Appl. No.: 14/224,558

(22) Filed: Mar. 25, 2014

Related U.S. Application Data
(60) Provisional application No. 61/805,517, filed on Mar. 26, 2013.

(51) Int. Cl. G06Q 30/02

(52) U.S. Cl. CPC G06Q 30/0254
USPC 705/14.52

(57) ABSTRACT

A system for obtaining metrics for online advertising uses multiple sources of user data, including panel data, social networking system data, and user data from other online service providers. To avoid data leakage that could occur if the different providers were to share their user data, an advertising server accesses user data from the various sources and applies rules for obtaining the advertising metrics from the various user data sources. The rules may determine what data to use when there are conflicts between the different sources. Derived data may also be used to provide an indication of underlying demographics data without revealing personal information from the data source.

### CROSS REFERENCE TO RELATED APPLICATIONS

This application claims the benefit of U.S. Provisional Application No. 61/805,517, filed Mar. 26, 2013, which is incorporated by reference in its entirety.

### BACKGROUND

This disclosure generally relates to the field of computer data storage and retrieval, and more specifically, to deriving information for estimating viewership of digital content such as online advertisements.

Disseminators of digital content via the Internet are often interested in estimating the viewership of that content. For example, advertisers that provide digital advertisements for display on websites are interested in estimating the number of impressions (total separate displays) that a particular advertisement produced with respect to different demographic attributes of interest, such as different age groups, males or females, those with particular interests (e.g., tennis), and the like.

In the context of television advertisements, selected surveying panels of households and/or individuals can be directly or indirectly surveyed regarding their television viewing habits. But these panels must be of a substantial size to be statistically representative, and thus panels are of little utility in contexts where there is not a large audience to be surveyed. For example, few, if any, individual websites have the number of viewers needed to form a panel providing sufficient accuracy.

Some websites, such as social networking sites, have a very large user base and thus have access to a wealth of demographic and statistical data. For example, user data on social networking sites typically includes information such as age, sex, and interests, as well as users' historical reactions to advertisements previously presented. However, the user base of these social networking sites typically does not perfectly represent, demographically, the population in general or that of another website on which advertisements might be placed. For example, the user demographics of a given social networking site are unlikely to perfectly match that of an online news website. Thus, although the user data on a social networking site could be directly used to estimate the effectiveness of an advertisement placed on the example online news website, the accuracy of the estimate could be enhanced.

Machine-based tracking techniques, such as the use of cookies employed by many advertising providers for tracking user reactions to advertisements, result in a large volume of data drawn from across many different websites. However, such data is associated with a particular computing device (e.g., a personal computer), rather than with an individual. In contrast, social networking sites and other login-based systems avoid the problems of multiple people sharing the same computer device, or one person using multiple distinct computer devices.

Additionally, users of online systems may interact with a variety of data sources and provide different information to each. Each data source may also be governed by a privacy policy that may not allow for sharing of personally identifiable information. For example, one data source may know that a user is a male between 25 and 35, a second data source may know that the user is male and graduated from college in 1999, and a third data source may know the user is between 25 and 35 and lives in California. Since each data source typically maintains its data separately, an advertiser is limited in knowing that an advertisement served to the user was served to a male between 25 and 35 who graduated from college in 1999 and lives in California.

### SUMMARY

A system is provided for determining the advertising reach and demographics of impressions of an advertisement. The system obtain metrics for online advertising using multiple sources of user data, such as panel data, social networking system data, and user data from other online service providers. In such a system, it would be valuable to correlate information from the multiple data sources to determine demographics and reach for advertisements without exposing actual data known by each data source, which may include personally identifiable information, to the other data sources.

A system for obtaining metrics for online advertising accesses data from multiple user data sources, which may include panel data, social networking system data, browser data, and user data from other online service providers. Each of the data sets may comprise demographic information about the users and statistics about the users. The data resulting from the combination may be used to compute an estimation model at an advertising server that more accurately estimates the users' viewership of content than would the use of the data of any given one of the different data sets when taken in isolation.

In one embodiment, the estimated viewing statistics produced by the model for an advertisement or other content comprise estimated statistics for values of a set of demographic attributes of interest. The estimated statistics may include a reach value (i.e., a number of distinct users estimated to have viewed the advertisement) and/or a frequency value (i.e., a number of times that an average user is estimated to have viewed the advertisement). For example, the values of demographic attributes of interest might include a set of age ranges, or males and females. Use of the rich data sets from social networking systems, for example, allows analysis of demographic attributes such as specific interests (e.g., a particular sport, such as tennis), education level, or number of friends that are entered by users of the social networking systems or inferred based on user activity. Viewing statistics with respect to combinations of demographic attributes (e.g., males aged 20-24) may also be analyzed.

The data sets are combined, resulting in a model that estimates viewing statistics for content for which the viewing statistics have not already been verified. The estimated viewing statistics may include values for the individual demographic attributes and/or combinations thereof, and aggregate values across all demographic groups (e.g., an estimated total number of impressions). The techniques that can be used to produce the estimation model include, for example, supervised learning and Bayesian techniques.

To avoid data leakage that could occur if the different user data sources were to share their user data with one another, the advertising server accesses the user data from the various data sources and obtains advertising metrics from these various sources. In certain instances, data from the various data sources may conflict, in which case conflict rules may determine what data to use. The conflict rules may resolve such conflicts with reference to the likelihood that a data source agrees with a trusted data source for the type of information that conflicts. For example, if a first and second data source conflict with regard to a user's age, the likelihood that each data source agrees with a trusted data source with respect to age may be referenced to select which data to use.

Derived data may also be used to permit exchange of some user information without violating user privacy, and may permit partial sharing of user demographic information without revealing any personally identifiable information. Derived data reflects underlying demographics information but does not reveal the demographics information. Derived data may comprise several types of data. One type of derived data is a logical combination of at least two types of demographics information (e.g., the user is either male or between 25 and 35). Another type of derived information is information reflecting the likelihood that a data source would agree with another data source with respect to the underlying demographics information (e.g., a first data source indicates a user is male, and the second data source indicates it agrees with respect to gender 95% of the time). Another type of derived information is information from a first data source indicating that either the first data source or the second data source indicates demographics information (e.g., data source A indicates that either data source A or B has data that a user is male, such that data source A does not indicate whether its information indicates a gender).

Using the data from the various data sources, when the advertising server receives an advertising impression associated with a user identifier, the advertising server receives user demographics information from the user data sources, which may include derived data. The user demographics are used to determine aggregated user demographics based on the user demographics information, which may further be based on the conflict rules described above. The aggregated user demographics are used to update a viewing statistics set associated with the advertising campaign of the advertising impression. The viewing statistics set includes aggregated user demographics for user identifiers that have viewed the advertisement. The viewing statistics set is applied to the estimation model to generate an estimated viewing statistics for advertisement. This permits the advertising server to generate viewing statistics for the advertisement without requiring user data sources to reveal sensitive data to one or more of the other data sources.

### BRIEF DESCRIPTION OF THE DRAWINGS

FIG. 1 is a high-level block diagram of a computing environment according to one embodiment.

FIG. 2 shows data communication for generating estimated viewing statistics according to one embodiment.

FIG. 3 is a flowchart illustrating steps for computing an estimation model and applying the estimation model to compute estimated viewing statistics for a given advertisement, according to one embodiment.

FIG. 4 illustrates data known by various data sources with regard to particular attributes of users.

FIGS. 5A and 5B show examples of derived data according to various embodiments.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### Overview

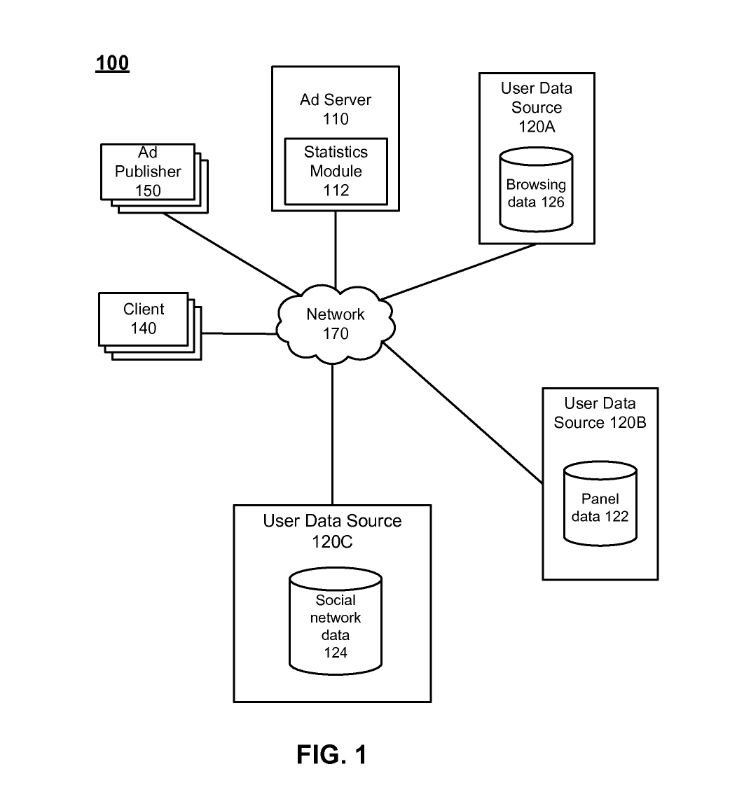

FIG. 1 is a high-level block diagram of a computing environment according to one embodiment. FIG. 1 shows an example environment for an advertising system for determining a estimated viewing statistics indicating correlated information from multiple user data sources 120A-120C (generally, 120) without exposing user data from the various data sources.

FIG. 1 illustrates a set of distinct data sources 120A, 120B, 120C storing data obtained based on prior activity of users, a set of client devices 140 used by the users to directly or indirectly provide the data stored by the data sources 120 and an advertising server 110 (alternatively, “ad server” 110) that includes a statistics module 114 used to combine and refine the information stored by the data sources 120. FIG. 1 additionally illustrates one or more ad publishers 150 that provide content and advertisements that users can view on the client devices 140, such as videos, images, and the like. As users browse content on the network 170, users visit various ad publishers 150, who generally provide a reference to the client 140 to the ad server 110 to retrieve an advertisement to accompany the content of the ad publisher 150.

The various data sources 120 may include different types of data relating to users, and in this example include user data source 120A including browsing data 126, user data source 120B storing panel data 122, and user data source 120C including social network data. Embodiments may include any number of user data sources, which may include various types of such user data. The panel data 122 represents the aggregate data provided by a set of households or individual users making up a panel, with respect to a particular website. A surveying panel is a group of people chosen to be statistically representative of the overall audience for some content of interest, such as the viewers of one of the ad publishers 150. The data tracked for a given panel typically includes information about the number of times that a household in the aggregate, or the individual members of the household, viewed content of interest, such as a particular advertisement, on the corresponding ad publisher 150. The data for a panel typically further includes general information on the household itself and/or the individual members thereof. For example, in one embodiment the panel data 122 includes advertisement information such as how many times each member of a particular household was presented with advertisements on the particular ad publisher 150, and demographic information such as the number of members of the household and the age and gender of each member, the location of the household, aggregate household income, and aggregate purchasing behavior (e.g., particular products purchased). The demographic information associated with the households tends to be highly accurate, since the panel members are surveyed and their answers confirmed before they are accepted as members of the panel. However, it may be difficult to determine which particular members of the household viewed the content.

Social network data 124 is derived, directly or indirectly, from use of a social network, such as viewing histories of content such as advertisements, videos, images, etc., and social information such as connections and profile information. For example, in one embodiment the social network data 124 comprises, for each distinct individual user, how many times that user was presented with a particular advertisement while using the social network, how many times the user “clicked” the advertisement, and manually-specified user information. The manually-specified user information is information about the user, including profile information such as user name, age, sex, birthday, interests (e.g., favorite sport or musical genre), and friends or other connections on a social networking system. Not all of the user information need be manually-specified by the user; some of the information may be inferred by the social networking system based on user activity or relationships (e.g., inferring that the user is interested in basketball based on frequent postings related to basketball, or on his affiliation with basketball-related organizations on the social networking system). Additionally, the social network data 124 would include, for each user, profile information and a list of the user's connections.

The social network data 124 represents a strong understanding of user identity, due to the login-based nature of the social networking system which requires some validation of user identity. The social network data 124 may contain inaccuracies due (for example) to user dishonesty when submitting information (e.g., a false age), though this inaccuracy may be mitigated by flagging and correcting possible inaccuracies based on other known data, as described in more detail below. The social network data 124 is typically rich, containing information on attributes that may have a strong influence on content viewing patterns, such as number of social network friends, number of books read over some recent time period. However, social network data 124 is also typically highly sensitive, may be personally identifiable, and is typically be subject to privacy policies for any sharing of data outside of a the social networking system that obtained the data.

User data source 120A includes browsing data 126, based on aggregated data from user web browsing on a client 140, e.g., via tracking cookies placed on the user's browsing device via HTTP response headers. The browsing data 126 includes, for a given device identifier such as an IP address, a browsing history comprising URLs visited from that device. The browsing data 126 typically lacks as strong a notion of user identity as the social network data 124. On the other hand, given that the browsing data 132 tends to include data on a large number of websites visited, resulting in a larger data set that is typically not subject to privacy policies or includes other personally identifiable information.

Users use the client devices 140 to provide data to various systems that directly or indirectly provide data to the data sources 120, and to view content, such as content available on an ad publisher 150. The data may be provided via the network 170, which is typically the Internet, but may also be any network, including but not limited to a LAN, a MAN, a WAN, a mobile, wired or wireless network, a private network, or a virtual private network. Large numbers (e.g., millions) of client devices 140 can be in communication with the various data sources 120 at any given time. The client devices 140 may include a variety of different computing devices. Examples of client devices 140 include personal computers, mobile phones, smart phones, laptop computers, tablet computers, and digital televisions or television set-top boxes with Internet capabilities. As will be apparent to one of ordinary skill in the art, other embodiments may include devices not listed above. Different types of client devices 140 may be more suited for communicating with different ones of the data sources 120. For example, devices with web browsers, such as personal computers, smart phones, and the like are particularly suited for interacting with a social networking system and with websites to provide social network data 124 and browsing data 126, whereas television set-top boxes may be more suitable for monitoring and providing panel data 122. Not all of the data stored by the various data sources 120 need be provided directly by the client devices 140 over the network 170. For example, panel members may provide information to a panel system in response to surveys provided via telephone or physical mail.

The data related to viewing of content is gathered in different manners for the different data sources 120. For example, the panel data 122 on content viewing is usually obtained as a result of user installation of software by members of the panel. Specifically, the members of a household that is part of the panel installs software on (for example) their personal computers, and the software tracks the content that the household members view and provides this information to the user data source 120B, which stores it as part of the panel data 122. The social network data 124 related to content viewing is captured directly by a social networking system, such as user data source 120C, which has knowledge of the accesses to content of its users. The browsing data 126 related to content viewing is typically obtained by an advertising network tracking user views of content via cookies supplied as part of a HTTP responses and stored on the user devices. Alternatively, the browsing data 126 may be collected by another data aggregation system that is not associated with an advertising network. The browsing data 126 may be organized according to a categorization, for example to identify specific interests or other categories associated with the browsing data. Thus, user visits to a website relating to wildlife may associate the browsing with a nature category.

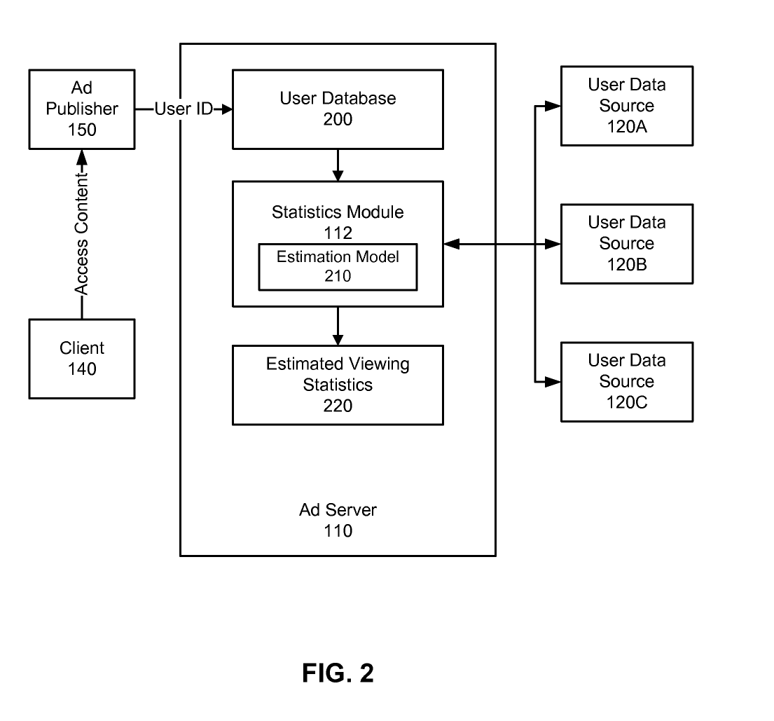

The advertising server 110 receives a request from a client 140 for an advertisement, typically via a referral from another system or service, such as ad publisher 150. The statistics module 112 computes an estimation model using a combination of data from two or more of the data sources 120. In one embodiment, the statistics module 112 additionally provides estimated viewing statistics for a given advertisement or other content using the estimation model. The operations of the statistics module 112 are discussed further below with respect to FIG. 2.

It is appreciated that FIG. 1 illustrates a computing environment 100 according to one particular embodiment, and that the exact constituent elements and configuration of the computing environment could vary in different embodiments. For example, although FIG. 1 depicts three specific user data sources—including panel data 122, social network data 124, and browsing data 126—there could be more or fewer user data sources, or user data sources of different types. For example, the environment 100 could include only user data source 120B with panel data 122 and user data source 120C with social network data 124, but not the user data source 120 with browsing data 126. As another example, the statistics module 112, although depicted in FIG. 1 as part of the advertising server 110, could reside on any system capable of accessing the data stored by the various information sources and protecting the potential confidentiality and privacy of any user demographic information.

FIG. 2 shows data communication for generating estimated viewing statistics according to one embodiment. When a user requests content at an ad publisher 150, the client 140 provides that request to the ad publisher 150. The ad publisher 150 includes an advertisement with the accessed content. To select and provide advertisements to the user, the ad publisher 150 provides a user id to the ad server 110. The ad publisher 150 may directly request an ad from the ad server 110 to provide to the client, or the client 140 may request an advertisement from the ad server 110 by following a reference, for example a URL, provided by the ad publisher 150. Rather than the ad publisher 150 providing the user ID, the user ID may be determined from the client 140 when the client 140 follows a reference to the ad server 110 and receives an ad. The ad server 110 associates the user ID with providing an impression of the advertisement served by the ad server 110. In one embodiment, the advertisement is provided by a separate system from the ad server 110, and the ad server 110 is provided the user ID to indicate that an advertising impression was viewed by the client 140. The advertisement impression is typically associated with an advertising campaign being run by an advertiser.

Though described with respect to serving an advertisement, the ad server 110 may also be provided an indication when a user interacts with the advertisement, for example by clicking on an advertisement or otherwise performing an action associated with the advertisement. This may be used to determine the frequency of click-through or conversion rate of an advertisement by particular demographic groups. The process may also be used to determine a user's exposure to non-sponsored content, such as broadcast programs.

The user ID is typically a browser ID, information from a cookie, or another persistent object on the client device identifying the client device and/or the user associated therewith. The user ID may also be log in credentials or another type of cookie for use with a data source. In addition to the user ID communicated to the ad server through ad publisher, the client may directly access a user data source through another reference and provide a user ID to the user data source 120. For example the ad publisher may include a link to a service operated by a user data source 120, for example to provide social networking functionality, or as part of an ad serving network.

As described above, the user data sources 120 may be any source of demographics information about users. Such data may include data regarding demographics data, purchase data, web browsing data, social networking data, and other information, which may be personally identifiable. When the ad server 110 receives the request for an advertisement from the client 140 or otherwise sends the advertisement to the client 140, the ad server 110 registers the advertisement sent to the user with a user database. If the user ID already exists in the user database, the ad server 110 may have some preexisting demographics or other data associated with the user ID.

As clients 140 access the ad server 110 and are provided advertisements, the user ID is sent to a statistics module 112 to update estimated viewing statistics 220, reflecting demographics and reach information for the served advertisements.

The user ID is provided to the statistics module 112 to determine estimated viewing statistics 220 for the user database associated with a given advertisement or advertising campaign. The statistics module 112 determines and updates estimated viewing statistics 220, which may reflect the gross ratings point (GRP) for an advertisement. The gross rating point is a measure of the advertising reach and impressions of an advertisement to various target demographics. The gross ratings point indicates the demographics of users viewing an advertisement and the numbers of such users. The GRP may reflect a number of impressions or may determine the number of unique viewers of an advertisement.

To generate the estimated viewing statistics 220, the statistics module 112 derives an estimation model 210 from sets of demographics data from the user data sources. The statistics module 112 receives the various types of user data from the user data sources 120, such as panel data 122, social network data 124, and browsing data 126. The statistics module 112 then combines the different data using a data integration technique, the specifics of which differ in different embodiments, resulting in an estimation model 210. For example, in one embodiment the statistics module 112 combines the panel data 112 for that website with the social network data 122.

In one embodiment, the statistics module 112 need not accept the data provided by the user data sources 120 as-is, but may instead modify the data for greater accuracy. That is, either the statistics module 112 can modify the data sets provided by the different data sources 120 before combining the data sets, or the content sources themselves can perform the modifications before providing the data sets to the statistics module 112. For example, a portion of the user-entered information within the social network data 122 may be rejected or modified based on other social data associated with that user, where the other social data indicates that the portion is inaccurate. As a specific example, a particular user may list herself in her profile as being 107 years old, but if the majority of her friends are aged 20-24, she has recently listed a college as her current educational institution, and she has a high school graduation date three years prior to the current date, her age might be adjusted to the most probably correct age (e.g., 21) before the statistics module 112 combines the social network data 122 with any other data set.

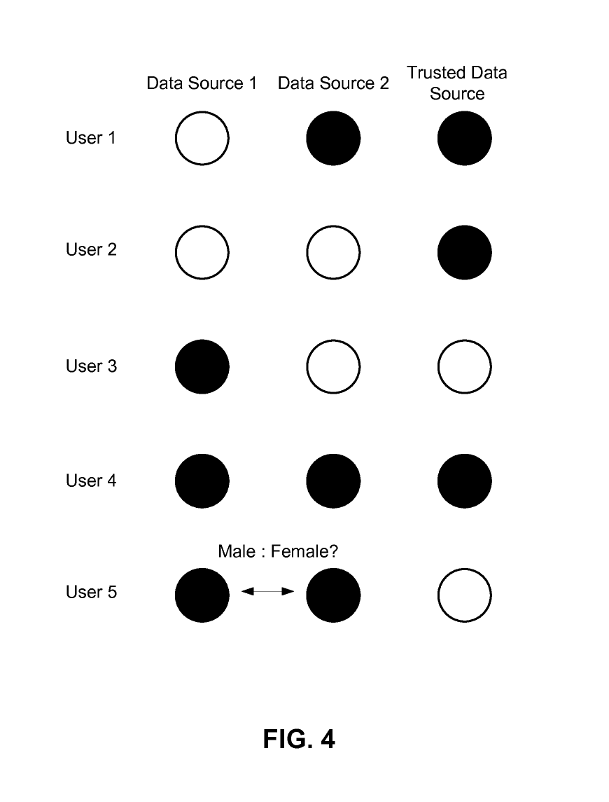

As described below, the statistics module 112 may modify the user data from the user data sources 120 when the data about a user conflicts with one another. Methods for managing such conflicting data are described below with respect to FIG. 4.

Different algorithms may be used in different embodiments to perform the derivation of the estimation model 240. For example, possible techniques include supervised machine learning, Bayesian techniques, or weighting segments, each of which is known to one of skill in the art. “Ground truth” may be supplied by, for example, performing a comprehensive survey regarding viewing of some subset of the content.

The estimation model 210, in essence, maps the viewing statistics for the different data sets 122, 124, 126 used to train the model to a single set of statistics that is more likely to be accurate. Thus, for given content for which actual viewing statistics have not been verified, viewing statistics produced by advertising impressions can be provided as inputs to the estimation model 210, which outputs a set of estimated viewing statistics 220 with greater probable accuracy than any input viewing statistics that may otherwise have been generated at individual user data sources.

In one embodiment, the estimated viewing statistics 220 produced by the estimation model 210 for a given advertisement or other content comprise, for each demographic attribute of interest (or combinations of demographic attributes, such as males aged 15-19), estimated viewing statistics. In one embodiment, the estimated viewing statistics 220 include the reach and frequency of the advertisement. As an example for a hypothetical set of data, the viewing statistics could include, in part, the following data, illustrating estimated statistics for various demographic attributes (i.e., age groups 15-19 and 20-25, males, females, and those interested in basketball):

| Attribute | Reach | Frequency |
|---|---|---|
| Age 15-19 | 15,282 | 2.83 |
| Age 20-25 | 20,969 | 3.4 |
| Sex: Male | 25,892 | 2.38 |
| Sex: Female | 35,223 | 5.4 |
| Interest: | 12,347 | 1.3 |
| Basketball | | |

Thus, in viewing the estimated statistics of this example, the advertiser associated with the advertisement could determine that the advertisement likely fared considerably better with women than with men, and somewhat better with the age group 15-19 than with the age group 20-25, for example, in addition to determining the estimated reach and frequency values themselves.

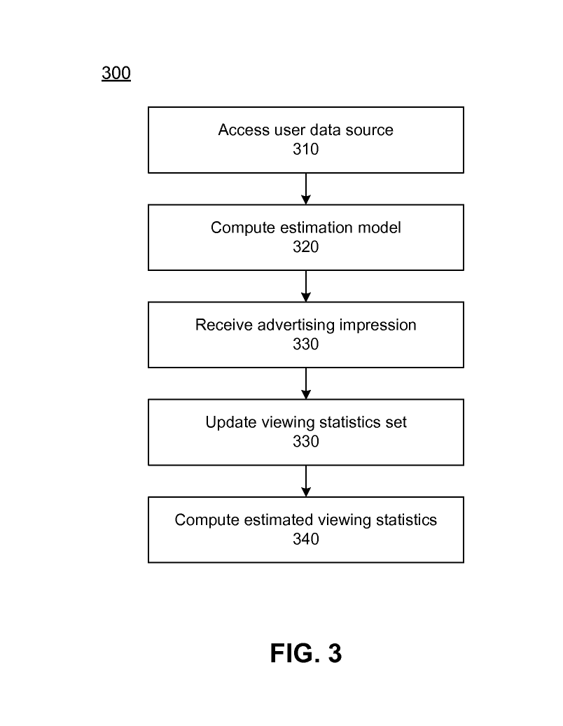

FIG. 3 is a flowchart illustrating steps performed by the statistics module 112 when computing the estimation model 210 and applying the estimation model to compute estimated viewing statistics 220 for a given advertisement, according to one embodiment. In step 310, the statistics module 112 accesses user data source information from the various user data sources 120.

In step 320, the statistics module 112 computes the estimation model 210 from the demographics data of the user data sources using one of the techniques noted above, such as machine learning or Bayesian techniques. The estimation model 210 can be viewed in one example as being representative of the social network data 124, adjusted by the panel data 122, thereby tailoring the social network data to a representative audience.

With the estimation model 210 having been derived, the statistics module 112 can apply the estimation model 210 to estimate the viewing statistics for a given advertisement, or other content of interest. Specifically, the statistics module 112 applies a viewing statistics set to the estimation model 210. The viewing statistics set reflects the users that are associated with having viewed a particular advertisement.

To generate the viewing statistics set, when the statistics module 112 receives a user ID for an advertising impression 330, the statistics module 112 requests user data relating to the user ID from the user data sources 120. The user data received from the sources is associated with the user ID and the user's information is added to the viewing statistics set and update it 330. The user data received from the data sources may also be adjusted according to conflict rules as indicated above and more fully described below. For each user, aggregated user demographics may be generated using the demographic data from each user data source. The aggregated user demographics may be a concatenation of the data from each data source 120, or may reflect the data modified by the conflict rules.

The advertising system provides viewing statistics set to the estimation model 210, thereby computing 350 estimated viewing statistics 220 for display of the advertisement. As described above, such estimated viewing statistics 220 include, for values of each demographic attribute of interest (e.g., various age groups, or male/female groups), estimated viewing statistics, such as the estimated reach and frequency of the advertisement.

By placing the statistics module 112 in the ad server 110, the advertising server can provide estimated viewing statistics 220 to the advertiser without requiring an identification of the advertisement to another entity outside the ad server (e.g., to user data sources 120), enables real-time updates of the estimated viewing statistics, capturing impressions of the advertisement, and enables GRP calculations without sharing personally identifiable information from the data sources or between data sources.

### Resolving Data Conflicts

FIG. 4 illustrates data known by various data sources with regard to particular attributes of users. Conflicts between various data sources may be resolved by the statistics module 112, and may be resolved when an estimation model 210 is generated or when a user ID is queried at the user data sources 120 responsive to receipt of an ad impression. As shown, one data source is considered a trusted data source, which is more trustworthy than other data sources. The trusted data source may obtain its information, for example, by determining a verified panel of users, by survey data, or by other trusted means of identifying demographics information about a user. A filled circle indicates that the data source has information for that particular user. Here, the trusted data source (TDS) and data source (DS) 2 has data on user 1. Only TDS has information on user 2. Only DS1 has information on user 3. Each of the illustrated data sources has information relating to user 4. DS1 and DS2 have information on user 5, but TDS does not. Data collected by the various sources may conflict. In this example, suppose DS1 and DS2 conflict on whether user 5 is male or female. DS1 indicates user 5 is male, DS2 indicates the user is female.

One of the rules mentioned above resolves the conflict by determining which data source is more likely to have accurate data on user 5. Each DS may be better at collecting user data for different types of users. Thus, determining which set of users that user 5 is similar to may better determine which DS is correct about user 5's gender. To resolve this discrepancy, user 5 is compared to other user cases where DS1 and DS2 were correct about other users relative to the information known by the trusted data source. One method of determining this is to apply a Bayesian model of probability (e.g. given X, probability Y). One method is to obtain a training set for when DS1 and DS2 have conflicting data, and TDS has trusted data to indicate when DS1 and DS2 are correct. Using the training set, a computer model can be trained to determine the circumstances when DS1 is more likely to be correct and the circumstances when DS2 is more likely to be correct. This is extrapolated to the case where TDS does not have any data but DS1 and DS2 do conflict.

In another method, a voting model is used that uses the portion of times DS1 is correct when it has data (as compared to TDS) compared to the portion of times DS2 is correct when it has data (as compared to TDS).

In another voting method, the number of data sources indicating the user has a particular attribute is used. Thus, where no trusted data source indicates the gender, the other data sources may vote using the number of data sources. Though this example uses two data sources, in practice many data sources may conflict without a TDS to indicate the “true” answer. In this voting method, if 5 data sources indicate “male” and 2 data sources indicate “female,” the user is treated as male on a raw “vote” of the data sources.

In a further example, the conflict is resolved based on a frequency score that each data source is correct with respect to a particular attribute and the trusted data source. For example, DS1 may be correct about gender 90% of the time relative to TDS, while DS 2 is correct about gender 85% of the time relative to TDS. In this case DS1 is more trustworthy with respect to gender if DS1 and DS2 conflict.

### Derived Data

To protect user data, rather than provide direct user information such as gender (or, e.g., some hashed data representing the user data), data derived from user information may be used. Such derived data typically provides an indicator of the underlying data without providing the data itself. In the following examples, gender is used as the underlying data. This derived data may be used in generating the estimation model 210 or in determining individual user identifier information.

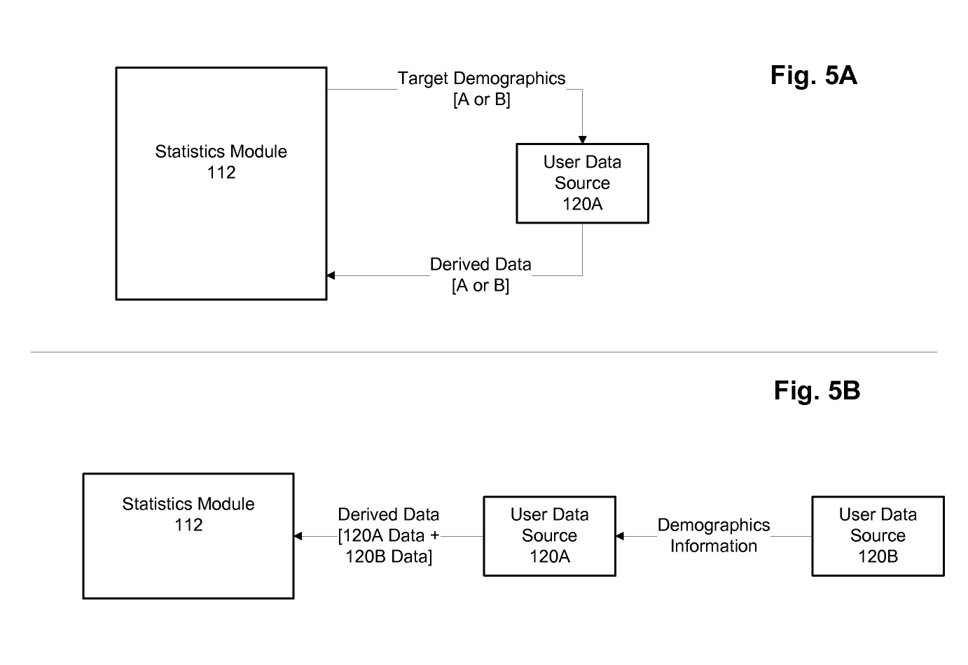

FIGS. 5A and 5B show examples of derived data according to various embodiments.

In the example shown in FIG. 5A, the derived data is a logical combination of at least two items of demographics information. For example, the logical combination may be a logical OR of two items of demographics information, such as indicating the target demographic item (e.g., gender) OR another demographic item about the user. Thus, rather than confirm that the user is male, the data source indicates the user belongs to the group (is male OR watched TV at 9 p.m. on Sunday). Since the gender is obscured by the addition an additional detail, the gender is not directly revealed. To take advantage of this technique, the advertiser's target demographics for the advertisement as reported by the estimated viewing statistics 220 may use similar derived data. For example, the estimated viewing statistics 220 may indicate the advertisement was viewed by a number of users aged between 25 and 35 or male. Thus the report does not indicate directly the number of users between 25 and 35 or the number that are male.

To acquire such derived statistics, the statistics module provides the target demographics for an advertisement or other acceptable combinations of target demographics to the user data source 120A. In this case, the statistics module 112 indicates that it requests a logical combination of demographic targeting information for attributes A or B. User data source 120A identifies users that match A or B, which may include users that match A AND B, and provides this derived data to statistics module 112.

FIG. 5B shows another example of derived data, which is an indication from a data source that another data source is likely to be correct about the target data item. Thus, rather than provide the data item, the data source analyzes data from the second data source to determine the likelihood that the data source will agree with the data from the second data source. The likelihood of agreement can use a data model trained on prior responses from the second data source. Thus, the first data source indicates, rather than the first data source's actual indicator, an indicator of the likelihood that the second data source is correct. For example, the first data source may indicate that for this user ID, the second data source is likely to be correct about gender 90% of the time. In many cases, this is typically valuable when the second data source is more willing to share the data item than the first data source, but the first data source can provide some indication of its data. In this example, user data source 120B provides its demographics information to user data source 120A. User data source 120A computes the likelihood that it agrees with user data source 120B and provides this likelihood along with the data of user data source 120B to the statistics module 112.

In another example of derived data, a first data source provides its data only as a modification to data provided by a second data source. For example, the first data source may provide an indication that the first data source OR the second data source indicated a gender was male. Likewise, the first data source may provide an indication only if neither the first data source nor the second data source indicated the gender was male. In this way, the statistics module 112 which receives data from the first data source cannot determine if the indication is derived from data at the first data source or the second data source. In this instance, the data source 120B provides its demographic information to the first data source 120A, but does not provide its demographic information to the statistics module. The data source 120A supplements the demographic information to generate indication that the first or second data source provided the demographic information. The first data source provides the supplemented demographic information to the statistics module. In this way, if the user data source 120A provides information that a user is male, that information reflects only that either user data source 120A or user data source 120B indicates the user is male, rather than indicating which user data source held that information.

### SUMMARY

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments are intended to be illustrative, but not limiting, of the scope of the embodiments, which is set forth in the following claims.

What is claimed is:

1. A method comprising:
identifying a user identifier associated with an advertising impression of an advertising campaign;
receiving, at an advertising server, user demographics for the user identifier, the user demographics received from a plurality of user data sources, each user data source maintaining a different set of data relating to the user identifier, wherein the user demographics are not shared between user data sources;
determining, at the advertising server, aggregated user demographics for the user identifier based on the received user demographics;
updating a viewing statistics set associated with the advertising campaign with the aggregated user demographics; and
computing, at the advertising server, estimated viewing statistics for the advertising campaign by applying an estimation model to the viewing statistics set.

2. The method of claim 1, wherein the plurality of user data sources comprise panel data, social networking data, and browsing data.

3. The method of claim 1, wherein the user demographics do not comprise personally identifiable information.

4. The method of claim 1, wherein determining aggregated user demographics comprises, for one item of user demographic information: receiving a first value from a first user data source, receiving a second value from a second source, and applying a conflict rule to determine an output value for the item of demographic information. resolving conflicts between user data sources.

5. The method of claim 4, wherein determining the output value using the conflict rule comprises selecting between the first and second value based on frequency score that the first user data source provides demographics data consistent with a trusted data source.

6. The method of claim 4, wherein determining the output value using the conflict rule comprises resolving conflicts between user data sources based on a Bayesian model of probability.

7. The method of claim 4, wherein determining the output value using the conflict rule is based on a voting of the number of user data sources for an outcome.

8. The method of claim 1, wherein determining the aggregated user demographics comprises, for an item of user demographic information of the aggregated user demographics: obtaining values for the item of information from a derived value for the item of information as a function of an obtained value at a user data source.

9. The method of claim 8, wherein the derived data comprises a logical combination of at least two obtained values of items of demographics information.

10. The method of claim 8, wherein the derived data comprises a likelihood that a data source will agree with demographics data from another data source.

11. The method of claim 8, wherein the derived data comprises an indication that a first data source or a second data source indicates a demographic information, but does not indicate which data source provided the demographic information.

12. The method of claim 8, wherein the data source is a social networking system, and the derived data comprises indirectly reflecting the information at the social networking system.

13. A non-transitory computer-readable medium storing instructions, the instructions when executed by a processor causing the processor to perform steps comprising:
identifying a user identifier associated with an advertising impression of an advertising campaign;
receiving user demographics for the user identifier, the user demographics received from a plurality of user data sources, each user data source maintaining a different set of data relating to the user identifier, wherein the user demographics are not shared between user data sources;
determining aggregated user demographics for the user identifier based on the received user demographics;
updating a viewing statistics set associated with the advertising campaign with the aggregated user demographics; and
computing estimated viewing statistics for the advertising campaign by applying an estimation model to the viewing statistics set.

14. The computer-readable medium of claim 13, wherein the plurality of user data sources comprise panel data, social networking data, and browsing data.

15. The computer-readable medium of claim 13, wherein the user demographics do not comprise personally identifiable information.

16. The computer-readable medium of claim 13, wherein determining aggregated user demographics comprises, for one item of user demographic information: receiving a first value from a first user data source, receiving a second value from a second source, and applying a conflict rule to determine an output value for the item of demographic information. resolving conflicts between user data sources.

17. The computer-readable medium of claim 16, wherein determining the output value using the conflict rule comprises selecting between the first and second value based on frequency score that the first user data source provides demographics data consistent with a trusted data source.

18. The computer-readable medium of claim 16, wherein determining the output value using the conflict rule comprises resolving conflicts between user data sources based on a Bayesian model of probability.

19. The computer-readable medium of claim 16, wherein determining the output value using the conflict rule is based on a voting of the number of user data sources for an outcome.

20. The computer-readable medium of claim 13, wherein determining the aggregated user demographics comprises, for an item of user demographic information of the aggregated user demographics: obtaining values for the item of information from a derived value for the item of information as a function of an obtained value at a user data source.
